(19) United States
(12) Patent Application Publication
(10) Pub. No.: US 2024/0200688 A1
(43) Pub. Date: Jun. 20, 2024

(54) METHOD FOR CALIBRATING AN ELECTRONIC EXPANSION VALVE WITHIN A THERMAL MANAGEMENT DEVICE FOR A MOTOR VEHICLE

(71) Applicant: VALEO SYSTEMES THERMIQUES, La Verriere (FR)

(72) Inventors: Rody EL CHAMMAS, La Verriere (FR); Jinming LIU, La Verriere (FR); Patricia GARDIE, La Verriere (FR); Muriel PORTO, La Verriere (FR); Wissem NOUAINIA, La Verriere (FR); Thomas GUENET, La Verriere (FR)

(73) Assignee: VALEO SYSTEMES THERMIQUES, La Verriere (FR)

(21) Appl. No.: 18/556,440

(22) PCT Filed: Apr. 26, 2022
(86) PCT No.: PCT/EP2022/060974

§ 371 Date: Oct. 20, 2023

(30) Foreign Application Priority Data
Apr. 29, 2021 (FR) FR2104529

(51) Int. Cl. F16K 37/00; B60H 1/00; B60H 1/32; F25B 41/35

(52) U.S. Cl. CPC F16K 37/0083; B60H 1/00885; B60H 2001/3267; F25B 41/35

(57) ABSTRACT

Method for calibrating an electronic expansion valve within a thermal management device of a motor vehicle, the opening of the expansion valve being drivable by an electric stepper motor, the expansion valve including a first stop referred to as lower in the direction of maximum closure of the expansion valve and a second stop referred to as upper in the direction of maximum opening of the expansion valve, each stop being a reference position for calibrating the expansion valve, the method having: determining a projected open position of the expansion valve, determining the number of steps between the projected open position of the expansion valve and the first and second stops, selecting, as reference position, the stop having the smallest number of steps in relation to the projected open position, calibrating the expansion valve by opening or closing the expansion valve to its selected reference position.

### TECHNICAL FIELD

The present invention relates to a method for calibrating an expansion valve. More particularly, it relates to an expansion valve within a thermal management device of a motor vehicle.

### BACKGROUND OF THE INVENTION

Within the framework of thermal management devices are cooling-type circuits and/or heat pumps. These circuits are based on the compression and expansion of a heat transfer fluid in order to cool or heat another element, such as an air flow intended for the vehicle interior and/or batteries if an electric or hybrid vehicle is involved.

These thermal management devices thus have at least one compressor for compressing the heat transfer fluid and at least one expansion valve for expanding it. These expansion valves are generally electronic expansion valves of which the opening is controlled by a driven stepper motor. These expansion valves also generally have a maximum closure where the heat transfer fluid cannot pass through the expansion valve, or can pass through it only to a small extent, and reference is then made to a stop function. These expansion valves also have a maximum opening where the heat transfer fluid can pass through the expansion valve with little or no drop in pressure.

In order to allow precise control of the opening of the expansion valves and thus of the drop in pressure of the heat transfer fluid, it is necessary to regularly calibrate said expansion valve. For this, the expansion valve generally has a first stop, referred to as lower stop, close to its maximum closure and a second stop, referred to as upper stop, close to its maximum opening. During this calibration operation, the stepper motor is actuated until one or the other of the first and second stops is reached, in order to define the exact position of the expansion valve. However, the increase in these calibration operations over time and the number of steps carried out by the stepper motor to perform them have an impact on the service life of said motor and thus on that of the expansion valve.

The aim of the present invention is therefore to at least partially overcome the drawbacks of the prior art and to propose a method for calibrating an electronic expansion valve that has a limited impact on the service life of the electronic expansion valve.

### BRIEF SUMMARY OF THE INVENTION

The present invention thus concerns a method for calibrating an electronic expansion valve within a thermal management device of a motor vehicle, the opening of said electronic expansion valve being drivable by an electric stepper motor, said electronic expansion valve comprising a first stop referred to as lower in the direction of maximum closure of the electronic expansion valve and a second stop referred to as upper in the direction of maximum opening of the electronic expansion valve, each stop being a reference position for calibrating the electronic expansion valve,
said method having the following steps:
   determining a projected open position of the electronic expansion valve,
   determining the number of steps between the projected open position of the electronic expansion valve and the first and second stops,
   selecting, as reference position, the stop which is the fewest number of steps away from the projected open position,
   calibrating the electronic expansion valve by opening or closing said electronic expansion valve to its selected reference position.

According to one aspect of the invention, where the initial open position of the electronic expansion valve is known when the request for calibration is made, the step of determining the number of steps between the projected open position of the electronic expansion valve and the first and second stops has an additional step,
during said additional step, the number of steps between the initial open position and the first stop is added to the number of steps between the first stop and the projected open position and the number of steps between the initial open position and the second stop is added to the number of steps between the second stop and the projected open position.

According to another aspect of the invention, the step of determining a projected position of the electronic expansion valve is performed on the basis of the forthcoming mode of operation of the thermal management device.

According to another aspect of the invention, the step of determining a projected position of the electronic expansion valve is performed on the basis of the external temperature in relation to a predefined temperature threshold.

According to another aspect of the invention, the thermal management device has a first electronic expansion valve disposed upstream of a first evaporator:
when the projected position of the first electronic expansion valve is a closed position, so as to block the circulation of a refrigerant fluid, if a request is made for calibration of said first electronic expansion valve, said calibration is performed on its first stop,
when the projected position of the first electronic expansion valve is an intermediate position, so as to allow the circulation of the refrigerant fluid with a drop in pressure, if a request is made for calibration of said first electronic expansion valve, said calibration is performed on its first stop.

According to another aspect of the invention, the thermal management device has a second electronic expansion valve disposed upstream of an evaporator-condenser, and where the projected position of the second electronic expansion valve is determined by the forthcoming mode of operation of the thermal management device and if it is an intermediate position, so as to allow the circulation of the refrigerant fluid with a drop in pressure, if a request is made for calibration of said second electronic expansion valve, said calibration is performed on the stop which is the fewest number of steps away.

According to another aspect of the invention, the thermal management device has a second electronic expansion valve disposed upstream of an evaporator-condenser, and where the projected position of the second electronic expansion valve is an intermediate position, so as to allow the circulation of the refrigerant fluid with a drop in pressure,
if a request is made for calibration of said second electronic expansion valve:
   said calibration is performed on the first stop if the external temperature is lower than the predefined temperature threshold,
   said calibration is performed on the second stop if the external temperature is greater than the predefined temperature threshold.

According to another aspect of the invention, the thermal management device has a second electronic expansion valve disposed upstream of an evaporator-condenser:
when the projected position of the second electronic expansion valve is a closed position, so as to block the circulation of a refrigerant fluid, if a request is made for calibration of said second electronic expansion valve, said calibration is performed on its first stop,
when the projected position of the second electronic expansion valve is an open position, so as to allow the circulation of the refrigerant fluid with little or no drop in pressure, if a request is made for calibration of said second electronic expansion valve, said calibration is performed on its second stop.

According to another aspect of the invention, the thermal management device has a third electronic expansion valve disposed upstream of a second evaporator, said third electronic expansion valve and second evaporator being disposed in parallel with the first electronic expansion valve and first evaporator:
when the projected position of the third electronic expansion valve is a closed position, so as to block the circulation of a refrigerant fluid, if a request is made for calibration of said third electronic expansion valve, said calibration is performed on its first stop,
when the projected position of the third electronic expansion valve is an intermediate position, so as to allow the circulation of the refrigerant fluid with a drop in pressure, if a request is made for calibration of said third electronic expansion valve, said calibration is performed on its first stop.

According to another aspect of the invention, the electronic expansion valve has a position sensor at each stop so as to determine when said electronic expansion valve is open as far as the stop.

According to another aspect of the invention, the electronic expansion valve has physical stops such that the position of the electronic expansion valve in which it is open as far as the stop is determined by the resistance to rotation perceived by the electric stepper motor.

### BRIEF DESCRIPTION OF THE DRAWINGS

Further features and advantages of the present invention will become more clearly apparent from reading the following description, which is given by way of non-limiting illustration, and with reference to the accompanying drawings, in which:

FIG. 1 shows a schematic depiction of a thermal management device,

FIG. 2 shows a schematic depiction of the thermal management device of FIG. 1 in a first cooling mode or a dehumidifying mode,

FIG. 3 shows a schematic depiction of the thermal management device of FIG. 1 in a second cooling mode,

FIG. 4 shows a schematic depiction of the thermal management device of FIG. 1 in a third cooling mode,

FIG. 5 shows a schematic depiction of the thermal management device of FIG. 1 in a first heat pump mode,

FIG. 6 shows a schematic depiction of the thermal management device of FIG. 1 in a second heat pump mode,

FIG. 7 shows a functional diagram of the steps of the calibration method,

FIG. 8 shows a schematic depiction of the calibration run for an electronic expansion valve according to a first example,

FIG. 9 shows a schematic depiction of the calibration run for an electronic expansion valve according to a second example, and

FIG. 10 shows a schematic depiction of the calibration run for an electronic expansion valve according to a third example.

### DETAILED DESCRIPTION OF THE INVENTION

In the various figures, identical elements bear the same reference numbers.

The following embodiments are examples. Although the description refers to one or more embodiments, this does not necessarily mean that each reference relates to the same embodiment, or that the features apply only to one embodiment. Single features of different embodiments can also be combined and/or interchanged in order to create other embodiments.

In the present description, certain elements or parameters can be indexed, for example first element or second element and also first parameter and second parameter or first criterion and second criterion, etc. In this case, this is simply indexing to differentiate and designate elements or parameters or criteria that are similar but not identical. This indexing does not imply a priority of one element, parameter or criterion over another and such denominations can be easily interchanged without departing from the scope of the present description. Neither does this indexing imply any chronological order for example in assessing any given criterion.

In the present description, “upstream” is intended to mean that an element is placed before another with respect to the direction of circulation of a flow of air or of a fluid. By contrast, “downstream” is intended to mean that an element is placed after another with respect to the direction of circulation of a flow of air or of a fluid.

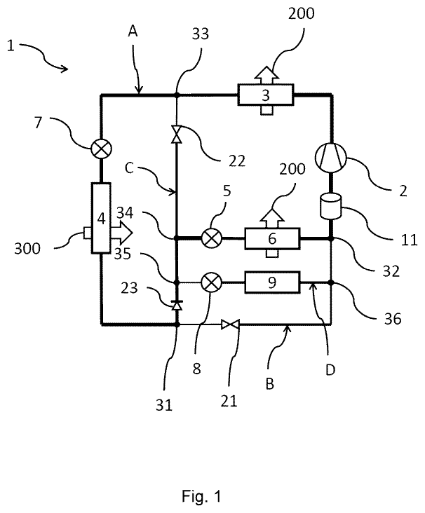

FIG. 1 first of all shows an example of a thermal management device 1. This thermal management device 1 in this case has a circuit for heat transfer fluid, more specifically a refrigerant fluid, configured for the thermal management of an internal air flow 200 intended for the vehicle interior and of batteries within an electric or hybrid vehicle. In the example presented, the thermal management device 1 is reversible, that is to say that it is configured to cool the internal air flow 200 and/or the batteries in different cooling modes but also is able to operate in one or more heat pump modes in order for example to heat the internal air flow 200.

However, it is possible to imagine other thermal management device architectures without departing from the scope of the invention.

As illustrated in FIG. 1, the thermal management device 1 has a loop referred to as main loop A (depicted in bold line) having the following in the direction of circulation of the refrigerant fluid: a compressor 2, an internal condenser 3, an evaporator-condenser 4 and a first evaporator 6. A first expansion device 5 is disposed upstream of the first evaporator 6. A second expansion device 7 is also disposed upstream of the evaporator-condenser 4. The main loop A can also have a refrigerant fluid accumulator 11 disposed upstream of the compressor 2.

The evaporator-condenser 4 is configured to be passed through by an external air flow 300. For this, the evaporator-condenser 4 is notably intended to be disposed in the front face of the motor vehicle. The internal condenser 3 and the first evaporator 6, for their part, are for example configured to be passed through by an internal air flow 200 intended for the vehicle interior. The internal condenser 3 and the first evaporator 6 are thus for example disposed within a heating, ventilation and air-conditioning device (not depicted). Within this heating, ventilation and air-conditioning device, the first evaporator 6 can more particularly be disposed upstream of the internal condenser 3 in the direction of circulation of the internal air flow 200. A device for blocking the internal air flow 200, for example a flap (not depicted), can also be present within the heating, ventilation and air-conditioning device in order to prevent or not prevent the internal air flow 200 from passing through the internal condenser 3.

The thermal management device 1 also has a first bypass B connecting a first junction point 31 to a second junction point 32. The first junction point 31 is disposed on the main loop A downstream of the evaporator-condenser 4, between said evaporator-condenser 4 and the first expansion device 5. The second junction point 32, for its part, is disposed on the main loop A downstream of the first evaporator 6, between said first evaporator 6 and the compressor 2. More specifically, it is upstream of the accumulator 11, for example. This first bypass B has a first shut-off valve 21 in order to allow or not allow the passage of the refrigerant fluid in said first bypass B.

In this example of FIG. 1, the thermal management device 1 also has a second bypass C connecting a third junction point 33 to a fourth junction point 34. The third junction point 33 is disposed on the main loop A downstream of the internal condenser 3, between said internal condenser 3 and the second expansion device 7. The fourth junction point 34, for its part, is disposed upstream of the first expansion device 5, between the first junction point 31 and said first expansion device 5. The second bypass C has a second shut-off valve 22 in order to allow or not allow the passage of the refrigerant fluid in said second bypass C. In order that the refrigerant fluid does not flow back to the evaporator-condenser 4 from the fourth junction point 34 when the second shut-off valve is open and when the refrigerant fluid is passing through the second bypass C, the main loop A can have a non-return valve 23. This non-return valve 23 is disposed on the main loop A upstream of the fourth junction point 34, between the first junction point 31 and the fourth junction point 34.

Lastly, the thermal management device 1 can have a third bypass D. This third bypass D has a third expansion device 8 disposed upstream of a second evaporator 9 or cooler. The third bypass D is more particularly connected on the main loop A in parallel with the first evaporator 6 and its first expansion device 5. The third bypass D thus connects a fifth junction point 35 to a sixth junction point 36. In the example presented, the fifth junction point 35 is disposed on the main loop A upstream of the fourth junction point 34, between the non-return valve 23 and said fourth junction point 34. The sixth junction point 36, for its part, is disposed on the first bypass B downstream of the first shut-off valve 21. The second evaporator 9 can notably be connected to an ancillary heat transfer fluid circuit (not depicted) enabling the thermal management for example of the batteries of an electric or hybrid vehicle. The second evaporator 9 thus allows heat energy to be exchanged between the refrigerant fluid circulating in the third bypass and a heat transfer fluid circulating in an ancillary heat transfer fluid circuit.

The first 5, second 7 and third 8 expansion devices can more particularly be a first 5, second 7 and third 8 electronic expansion valve, respectively. These electronic expansion valves 5, 7, 8 are drivable by an electric stepper motor between a maximum closure, where the electronic expansion valve 5, 7, 8 prevents the passage of the refrigerant fluid, and a maximum opening of the electronic expansion valve 5, 7, 8, where the expansion valve can allow the refrigerant fluid to pass with little or no drop in pressure.

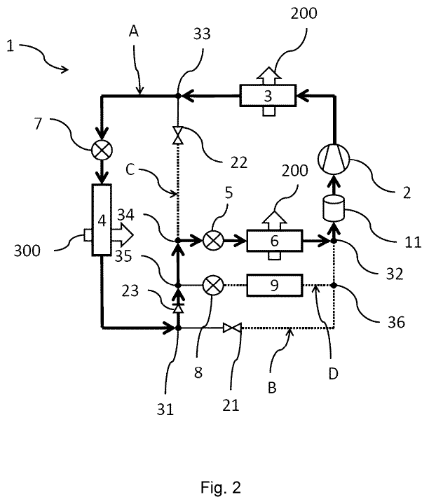

The thermal management device 1 of FIG. 1 is thus configured to function according to various modes of operation illustrated in FIGS. 2 to 6. In FIGS. 2 to 6, the direction of circulation of the refrigerant fluid is depicted by arrows. The dotted lines correspond to sections in which the refrigerant fluid is not made to circulate.

FIG. 2 shows a first cooling mode, in which the refrigerant fluid is compressed in the compressor 2, passes through the internal condenser 3 without exchanging with the internal air flow 200, and passes through the second electronic expansion valve 7 without experiencing a drop in pressure. The refrigerant fluid then passes through the evaporator-condenser 4, where it gives up heat energy to the external air flow 300. The refrigerant fluid then enters the first electronic expansion valve 5 at which it experiences a drop in pressure before passing through the first evaporator 6. As it passes through the first evaporator 6, the refrigerant fluid takes up heat energy from the internal air flow 200, enabling the latter to be cooled. The refrigerant fluid then returns to the compressor 2.

In this first cooling mode, the second electronic expansion valve 7 is open to its maximum extent, whereas the third electronic expansion valve 8 is closed to its maximum extent. The first 21 and second 22 shut-off valves, for their part, are closed.

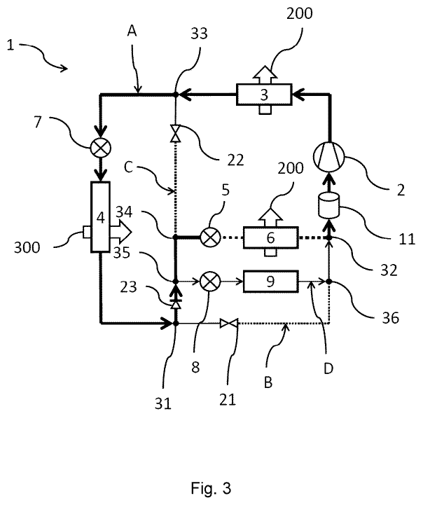

FIG. 3 shows a second cooling mode, in which the refrigerant fluid is compressed in the compressor 2, passes through the internal condenser 3 without exchanging with the internal air flow 200, and passes through the second electronic expansion valve 7 without experiencing a drop in pressure. The refrigerant fluid then passes through the evaporator-condenser 4, where it gives up heat energy to the external air flow 300. The refrigerant fluid then enters the third electronic expansion valve 8 at which it experiences a drop in pressure before passing through the second evaporator 9. As it passes through the second evaporator 9, the refrigerant fluid takes up heat energy from the batteries, enabling the latter to be cooled. The refrigerant fluid then returns to the compressor 2.

In this second cooling mode, the second electronic expansion valve 7 is open to its maximum extent, whereas the first electronic expansion valve 5 is closed to its maximum extent. The first 21 and second 22 shut-off valves, for their part, are closed.

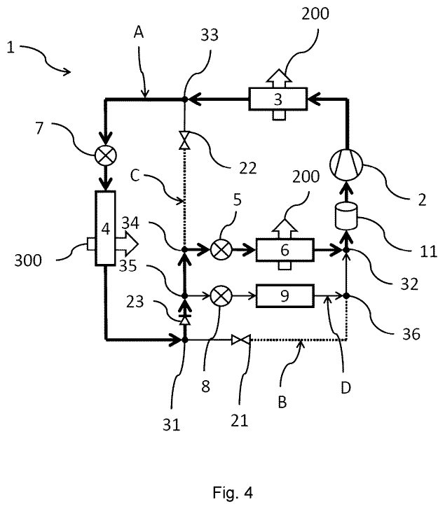

FIG. 4 shows a third cooling mode, which is a mixed mode consisting of the first and the second cooling mode. In this third cooling mode, the refrigerant fluid is compressed in the compressor 2, passes through the internal condenser 3 without exchanging with the internal air flow 200, and passes through the second electronic expansion valve 7 without experiencing a drop in pressure. The refrigerant fluid then passes through the evaporator-condenser 4, where it gives up heat energy to the external air flow 300.

A portion of the refrigerant fluid then enters the third electronic expansion valve 8 at which it experiences a drop in pressure before passing through the second evaporator 9. As it passes through the second evaporator 9, the refrigerant fluid takes up heat energy from the batteries, enabling the latter to be cooled.

Another portion of the refrigerant fluid enters the first electronic expansion valve 5 at which it experiences a drop in pressure before passing through the first evaporator 6. As it passes through the first evaporator 6, the refrigerant fluid takes up heat energy from the internal air flow 200, enabling the latter to be cooled.

These two portions of refrigerant fluid recombine at the second junction point 32 before returning to the compressor 2.

In this third cooling mode, the second electronic expansion valve 7 is open to its maximum extent. The first 21 and second 22 shut-off valves, for their part, are closed.

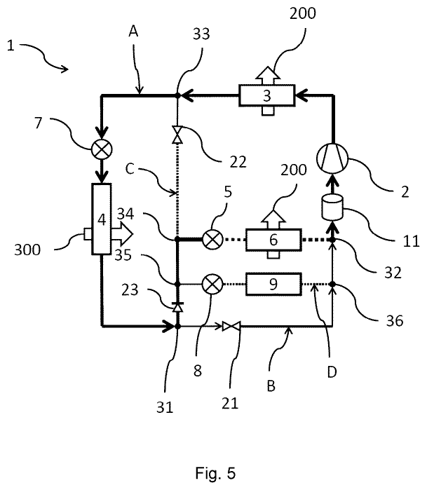

FIG. 5, for its part, shows a first heat pump mode in which the refrigerant fluid is compressed in the compressor 2 and then passes through the internal condenser 3 in which the refrigerant fluid gives up heat energy to the internal air flow 200 to heat the latter. The refrigerant fluid then enters the second electronic expansion valve 7, through which it passes with a drop in pressure. The refrigerant fluid then passes through the evaporator-condenser 4, where the refrigerant fluid takes up heat energy from the external air flow 300. The refrigerant fluid then returns to the compressor 2, passing via the first bypass B.

In this first heat pump mode, the first 5 and third 8 electronic expansion valves are closed. The first shut-off valve 21 is open and the second shut-off valve 22 is closed.

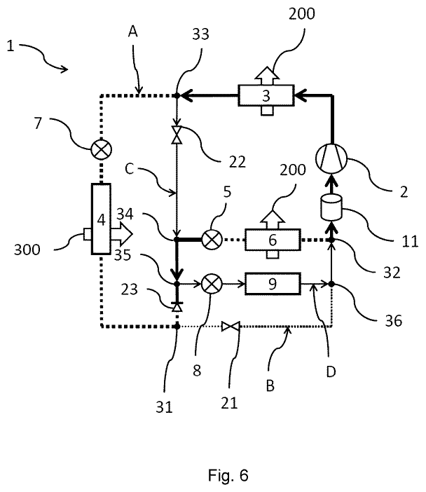

FIG. 6 shows a second heat pump mode for energy recovery, in which the refrigerant fluid is compressed in the compressor 2 and then passes through the internal condenser 3 in which the refrigerant fluid gives up heat energy to the internal air flow 200 to heat the latter. The refrigerant fluid then enters the second bypass C to reach the third electronic expansion valve 8, through which it passes with a drop in pressure. The refrigerant fluid then passes through the second evaporator 9, where the refrigerant fluid takes up heat energy from the batteries. The refrigerant fluid then returns to the compressor.

In this second heat pump mode, the first 5 and second π electronic expansion valves are closed. The first shut-off valve 21 is closed and the second shut-off valve 22 is open.

Another mode of operation can be a dehumidifying mode, in which the refrigerant fluid follows a path identical to that illustrated in FIG. 2. In this dehumidifying mode, the refrigerant fluid is compressed in the compressor 2 and then passes through the internal condenser 3 in which the refrigerant fluid gives up heat energy to the internal air flow 200 to heat the latter. The refrigerant fluid then enters the second electronic expansion valve 7, through which it passes with a first drop in pressure. The refrigerant fluid then passes through the evaporator-condenser 4, where the refrigerant fluid takes up heat energy from the external air flow 300. The refrigerant fluid then enters the first electronic expansion valve 5 at which it experiences a drop in pressure before passing through the first evaporator 6. As it passes through the first evaporator 6, the refrigerant fluid takes up heat energy from the internal air flow 200, enabling the latter to be cooled. The refrigerant fluid then returns to the compressor 2.

In this dehumidifying mode, the third electronic expansion valve 8 is closed to its maximum extent. The first 21 and second 22 shut-off valves, for their part, are closed.

These various modes of operation thus depend on the degree to which the electronic expansion valves 5, 7, 8 are open or closed. In order to calibrate these electronic expansion valves 5, 7, 8, they comprise:
a first stop X1 referred to as lower in the direction of maximum closure of the electronic expansion valve 5, 7, 8 and
a second stop X2 referred to as upper in the direction of maximum opening of the electronic expansion valve 5, 7, 8.

Each stop X1, X2 is a reference position for calibrating the expansion valve.

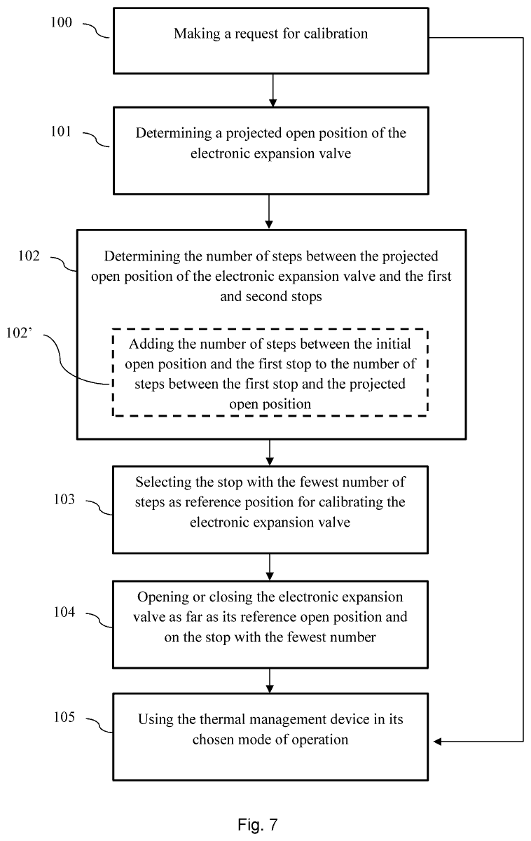

The calibration method according to the invention is illustrated in the diagram in FIG. 7. More specifically, this calibration method has the following steps:
a first step 101 of determining a projected open position Z of the electronic expansion valve 5, 7, 8,
a second step 102 of determining the number of steps between the projected open position Z of the electronic expansion valve 5, 7, 8 and the first X1 and second X2 stops,
a third step 103 of selecting, as reference position for the calibration, the stop X1, X2 which is the fewest number of steps away from the projected open position Z, and
a fourth step 104 of calibrating by opening or closing said electronic expansion valve 5, 7, 8 to its selected reference position.

After this fourth step 104, the thermal management device can enter a final step 105 of using the thermal management device 1 in its chosen mode of operation.

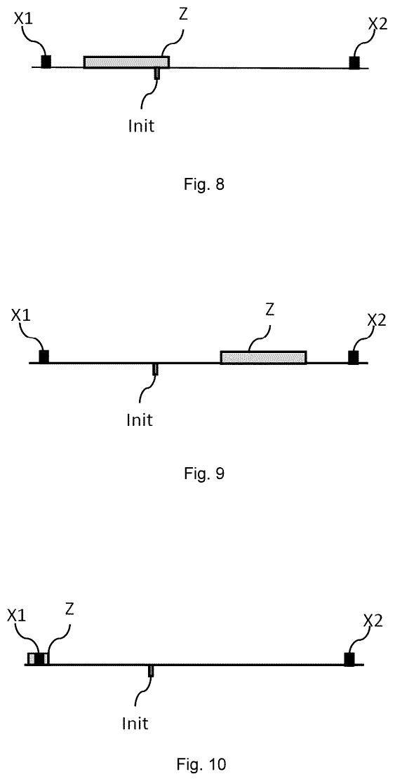

The projected position Z and also the first X1 and second X2 stops are depicted in FIGS. 8 to 10, which schematically show the opening ranges of an electronic expansion valve 5, 7, 8. The initial open position Init of the expansion valve 5, 7, 8 is also depicted in FIGS. 8 to 10.

Such a calibration method thus makes it possible to choose the calibration pathway having the fewest number of steps for the stepper motor. This therefore makes it possible to lengthen the service life of the stepper motor and therefore that of the electronic expansion valve 5, 7, 8.

This calibration method can notably be preceded by a prior step 100 of making a request for calibration. This request for calibration is notably linked to the fact that the calibration can be performed periodically, according to the setpoints and requirements of the manufacturer, and/or each time the thermal management device 1 is started up, for example when the motor vehicle is started up. If such a prior step 100 of making a request for calibration is not effective, the thermal management device 1 can be used directly. In the diagram of FIG. 7, this manifests itself in a direct connection of this prior step 100 to the final step 105 of using the thermal management device 1.

The first step 101 of determining a projected open position Z of the electronic expansion valve 5, 7, 8 can notably be performed on the basis of the forthcoming mode of operation of the thermal management device 1. This is because each mode of operation implies a predefined open position or at least a predefined opening range for each electronic expansion valve 5, 7, 8. As a result, depending on a user's or an automatic air-conditioning system's choice of mode of operation, it is possible to determine a projected open position Z of the electronic expansion valve 5, 7, 8.

The first step 101 of determining a projected open position Z of the electronic expansion valve 5, 7, 8 can also be performed on the basis of an external temperature in relation to a predefined temperature threshold. External temperature in this case is understood to mean a temperature external to the thermal management device 1. This external temperature can be for example the ambient temperature outside the motor vehicle, the temperature of the batteries or the temperature of a heat transfer fluid circulating in the ancillary heat transfer fluid circuit. In the same way as for the forthcoming mode of operation, the external temperature can also imply a predefined open position or at least a predefined opening range for each electronic expansion valve 5, 7, 8. As a result, on the basis of the external temperature and notably whether it is lower or greater than a predefined threshold, it is possible to determine a projected open position Z of the electronic expansion valve 5, 7, 8.

FIG. 8 shows an example in which the projected position Z is located at a degree of opening of the electronic expansion valve 5, 7, 8 that is close to the first stop X1. This implies that the drop in pressure of the refrigerant fluid when it will pass through the electronic expansion valve 5, 7, 8 will be significant. This is for example the case for the first electronic expansion valve 5 in the following aforementioned modes of operation:
the first cooling mode (FIG. 2),
the third cooling mode (FIG. 4), and
the dehumidifying mode (FIG. 2).

For the second electronic expansion valve 7, this is the case solely in the first heat pump mode (FIG. 5).

For the third electronic expansion valve 8, this is the case in the following aforementioned modes of operation:
the second cooling mode (FIG. 3),
the third cooling mode (FIG. 4), and
the second heat pump mode (FIG. 6).

For its part, FIG. 9 shows an example in which the projected position Z is located at a degree of opening of the electronic expansion valve 5, 7, 8 that is close to the second stop X2. This implies that the drop in pressure of the refrigerant fluid when it will pass through the electronic expansion valve 5, 7, 8 will be less significant than in the example in FIG. 8. This is for example the case for the second electronic expansion valve 7 in the dehumidifying mode of operation.

Lastly, FIG. 10 shows an example in which the projected position Z is located at the first stop X1 of the electronic expansion valve 5, 7, 8. This implies that the electronic expansion valve 5, 7, 8 will be closed and not allow the refrigerant fluid to pass.

This is for example the case for the first electronic expansion valve 5 in the following aforementioned modes of operation:
the second cooling mode (FIG. 3),
the first heat pump mode (FIG. 5), and
the second heat pump mode (FIG. 6).

For the second electronic expansion valve 7, this is the case solely in the second heat pump mode (FIG. 6).

For the third electronic expansion valve 8, this is the case in the following aforementioned modes of operation:
the first cooling mode (FIG. 2),
the first heat pump mode (FIG. 5), and
the dehumidifying mode (FIG. 2).

Of course, it is possible to imagine other examples, notably in which the projected position Z is located at the second stop X2 of the electronic expansion valve 5, 7, 8. This implies that the electronic expansion valve 5, 7, 8 will be open to its maximum extent and allow the refrigerant fluid to pass with little or no drop in pressure. This is notably the case for example for the second electronic expansion valve 7 in the first (FIG. 2) and second (FIG. 3) cooling modes.

The second step 102 of determining the number of steps between the projected open position Z of the electronic expansion valve 5, 7, 8 and the first X1 and second X2 stops can be carried out if the initial open position Init of the electronic expansion valve 5, 7, 8 is not known when the request for calibration is made. In this case, only the number of steps between the projected open position Z of the electronic expansion valve 5, 7, 8 and the first X1 and second X2 stops is taken into account.

The second step 102 of determining the number of steps between the projected open position Z of the electronic expansion valve 5, 7, 8 and the first X1 and second X2 stops can, however, also be carried out if the initial open position Init of the electronic expansion valve 5, 7, 8 is known when the request for calibration is made. It is for example possible to know the initial open position Init of the electronic expansion valve 5, 7, 8 by knowing the previous mode of operation of the thermal management device 1. The second step 102 then has an additional step 102′.

During this additional step 102′, the number of steps between the initial open position Init and the first stop X1 is added to the number of steps between the first stop X1 and the projected open position Z. The number of steps between the initial open position Init and the second stop X2 is also added to the number of steps between the second stop X2 and the projected open position Z. This therefore makes it possible to take account of the initial open position Init of the electronic expansion valve 5, 7, 8 and therefore to have a value for the number of steps necessary for the calibration that is closest to the reality and therefore to be able to choose the calibration pathway requiring the fewest number of steps.

During the third step 103, the stop X1 or X2 with the fewest number of steps is selected as reference position for calibrating the electronic expansion valve 5, 7, 8.

The fourth step 104 of calibrating the electronic expansion valve 5, 7, 8, for its part, is carried out by opening or closing said electronic expansion valve 5, 7, 8 as far as its reference open position and on the stop X1, X2 with the fewest number of steps that was determined by the third step 103. As a result, the calibration is performed by closing the electronic expansion valve 5, 7, 8 as far as the first stop X1 if the latter was selected as reference position in the third step 103. Similarly, the calibration is performed by opening the electronic expansion valve 5, 7, 8 as far as the second stop X2 if the latter was selected as reference position in the third step 103. Detection of the moment the electronic expansion valve 5, 7, 8 opens as far as the stop X1, X2 can vary depending on the valve model.

According to a first embodiment, the electronic expansion valve 5, 7, 8 can have a position sensor at each stop (X1, X2) so as to determine when said electronic expansion valve 5, 7, 8 is open as far as the stop.

According to a second embodiment, the electronic expansion valve 5, 7, 8 can have physical stops X1, X2 such that the position of the electronic expansion valve 5, 7, 8 in which it is open as far as the stop can be determined by the resistance to rotation perceived by the electric stepper motor.

Performing the calibration at this reference open position of the electronic expansion valve 5, 7, 8 makes it possible to be certain of the open position of the electronic expansion valve 5, 7, 8 for precise use and effective control of its opening during the final step 105 of using the thermal management device 1 in its chosen mode of operation.

As a result, it is possible to establish various calibration strategies depending on which electronic expansion valve 5, 7, 8 needs to be calibrated.

For a thermal management device 1 having a first electronic expansion valve 5 disposed upstream of a first evaporator 6, such as for example for a thermal management device 1 described in FIG. 1, this first electronic expansion valve 5 can take two different positions depending on the modes of operation: an intermediate position or a closed position.

When the projected open position Z of the first electronic expansion valve 5 is a closed position, so as to block the circulation of a refrigerant fluid, if a request is made for calibration of said first electronic expansion valve 5, said calibration is performed on its first stop X1. This is notably possible as described above in the second cooling mode (FIG. 3), the first heat pump mode (FIG. 5) and the second heat pump mode (FIG. 6). This is because, irrespective of the initial open position Init of the first electronic expansion valve 5, the number of steps between its projected open position Z and the first stop X1 will necessarily be the fewest, as illustrated in FIG. 10.

Similarly, when the projected open position Z of the first electronic expansion valve 5 is an intermediate position, so as to allow the circulation of the refrigerant fluid with a drop in pressure, if a request is made for calibration of said first electronic expansion valve 5, said calibration is performed on its first stop X1. This is notably possible as described above in the first cooling mode (FIG. 2), the third cooling mode (FIG. 4) and the dehumidifying mode (FIG. 2). This is because, irrespective of the initial open position Init of the first electronic expansion valve 5, the number of steps between its projected open position Z and the first stop X1 will necessarily be the fewest, since on account of the function of the first evaporator 6, the projected open position Z will necessarily be closer to the first stop X1 than to the second stop X2, as illustrated in FIG. 8.

As a result, for this first electronic expansion valve 5, the calibration will be performed on the first stop X1 irrespective of the mode of operation forthcoming after the fourth step 104 of calibrating.

For a thermal management device 1 having a second electronic expansion valve 7 disposed upstream of an evaporator-condenser 4, such as for a thermal management device 1 described in FIG. 1, the calibration method and notably the second step 102 can be carried out either on the basis of the forthcoming mode of operation or on the basis of the external temperature. This second electronic expansion valve 7 can take three different positions depending on the modes of operation: an intermediate position, an open position or a closed position.

According to a first embodiment, the projected position Z of the second electronic expansion valve 7 is determined by the forthcoming mode of operation of the thermal management device 1.

The second electronic expansion valve 7 can have an intermediate position, so as to allow the circulation of the refrigerant fluid with a drop in pressure, in the first heat pump mode (FIG. 5) and in the dehumidifying mode (FIG. 6).

For a forthcoming mode of operation, such as the first heat pump mode (FIG. 5), the projected open position Z of the second electronic expansion valve 7 will be closer to the first stop X1 than to the second stop X2, as illustrated in FIG. 8. If a request is made for calibration, it will be performed on the first stop X1 corresponding to the pathway with the fewest number of steps. In this instance, the initial position (if known) can be taken into account in the third step 103 for determining the number of steps between the projected open position Z of the electronic expansion valve 5, 7, 8 and the first X1 and second X2 stops.

For a forthcoming mode of operation, such as the dehumidifying mode (FIG. 6), the projected open position Z of the second electronic expansion valve 7 will be closer to the second stop X2 than to the first stop X1, as illustrated in FIG. 9. If a request is made for calibration, it will be performed on the second stop X2 corresponding to the pathway with the fewest number of steps. In this instance, the initial position (if known) can be taken into account in the third step 103 for determining the number of steps between the projected open position Z of the electronic expansion valve 5, 7, 8 and the first X1 and second X2 stops.

The second electronic expansion valve 7 can have a projected position Z in a closed position, so as to block the circulation of a refrigerant fluid in the second heat pump mode (FIG. 6). As a result, when the projected position Z of the second electronic expansion valve 7 is a closed position, if a request is made for calibration of said second electronic expansion valve 7, said calibration is performed on its first stop X1. This is because, irrespective of the initial open position Init of the second electronic expansion valve 7, the number of steps between its projected open position Z and the first stop X1 will necessarily be the fewest, as illustrated in FIG. 10.

The second electronic expansion valve 7 can have a projected position Z in an open position, so as to allow the circulation of the refrigerant fluid with little or no drop in pressure, in the first (FIG. 2), second (FIG. 3) and third (FIG. 4) cooling modes. As a result, when the projected position Z of the second electronic expansion valve 7 is an open position, if a request is made for calibration of said second electronic expansion valve 7, said calibration is performed on its second stop X2. This is because, irrespective of the initial open position Init of the second electronic expansion valve 7, the number of steps between its projected open position Z and the second stop X2 will necessarily be the fewest.

According to a second embodiment, the projected open position Z of the second electronic expansion valve 7 can be determined on the basis of the external temperature. This external temperature can notably be measured by a dedicated sensor. This second embodiment is particularly suitable for the second electronic expansion valve 7, notably in modes of operation in which said second electronic expansion valve 7 can have an intermediate position, so as to allow the circulation of the refrigerant fluid with a drop in pressure, like in the first heat pump mode (FIG. 5) and like in the dehumidifying mode (FIG. 6).

If the external temperature is lower than the predefined temperature threshold, the calibration is performed on the first stop X1. This predefined temperature threshold can for example be 25° C. If the external temperature is lower than 25° C., irrespective of whether it is for the first heat pump mode or the dehumidifying mode, the projected open position Z will be closer to the first stop X1 than to the second stop X2, as illustrated in FIG. 8. This is because, in heat pump mode, as the external temperature is relatively low it is necessary for there to be a great drop in pressure of the refrigerant fluid in order to take up heat energy. The same applies for the dehumidifying mode.

If the external temperature is greater than the predefined temperature threshold, the calibration is performed on the second stop X2. This predefined temperature threshold can for example be 25° C. If the external temperature is greater than 25° C., irrespective of whether it is for the first heat pump mode or the dehumidifying mode, the projected open position Z will be closer to the second stop X2 than to the first stop X1, as illustrated in FIG. 9. This is because, in heat pump mode, as the external temperature is relatively high it is not necessary for there to be a great drop in pressure of the refrigerant fluid in order to take up heat energy. The same applies for the dehumidifying mode.

For a thermal management device 1 having a third electronic expansion valve 8 disposed upstream of a second evaporator 9, such as for example for a thermal management device 1 described in FIG. 1, this third electronic expansion valve 8 can take two different positions depending on the modes of operation: an intermediate position or a closed position.

When the projected open position Z of the third electronic expansion valve 8 is a closed position, so as to block the circulation of a refrigerant fluid, if a request is made for calibration of said third electronic expansion valve 8, said calibration is performed on its first stop X1. This is notably possible as described above in the first cooling mode (FIG. 2) and the first heat pump mode (FIG. 5). This is because, irrespective of the initial open position Init of the third electronic expansion valve 8, the number of steps between its projected open position Z and the first stop X1 will necessarily be the fewest, as illustrated in FIG. 10.

Similarly, when the projected open position Z of the third electronic expansion valve 8 is an intermediate position, so as to allow the circulation of the refrigerant fluid with a drop in pressure, if a request is made for calibration of said third electronic expansion valve 8, said calibration is performed on its first stop X1. This is notably possible as described above in the second cooling mode (FIG. 3), the third cooling mode (FIG. 4) and the second heat pump mode (FIG. 6). This is because, irrespective of the initial open position Init of the third electronic expansion valve 8, the number of steps between its projected open position Z and the first stop X1 will necessarily be the fewest, since on account of the function of the second evaporator 9, the projected open position Z will necessarily be closer to the first stop X1 than to the second stop X2, as illustrated in FIG. 8.

It can thus be clearly seen that, on account of this calibration method, it is possible to limit the number of steps necessary for the stepper motor to calibrate an electronic expansion valve. This therefore makes it possible to increase the service life of the stepper motor and therefore that of the electronic expansion valve as well.

What is claimed is:

1. A method for calibrating an electronic expansion valve within a thermal management device of a motor vehicle, the opening of said electronic expansion valve being drivable by an electric stepper motor, said electronic expansion valve including a first stop referred to as lower in the direction of maximum closure of the electronic expansion valve and a second stop referred to as upper in the direction of maximum opening of the electronic expansion valve, each stop being a reference position for calibrating the electronic expansion valve,
said method comprising:
determining a projected open position of the electronic expansion valve,
determining the number of steps between the projected open position of the electronic expansion valve and the first and second stops,
selecting, as reference position, the stop which is the fewest number of steps away from the projected open position,
calibrating the electronic expansion valve by opening or closing said electronic expansion valve to its selected reference position.

2. The method according to claim 1, wherein when the initial open position of the electronic expansion valve is known when the request for calibration is made, determining the number of steps between the projected open position of the electronic expansion valve and the first and second stops includes adding the number of steps between the initial open position and the first stop to the number of steps between the first stop and the projected open position and adding the number of steps between the initial open position and the second stop to the number of steps between the second stop and the projected open position.

3. The method according to claim 1, wherein determining a projected position of the electronic expansion valve is performed on the basis of the forthcoming mode of operation of the thermal management device.

4. The method according to claim 1, wherein determining a projected position of the electronic expansion valve is performed on the basis of the external temperature in relation to a predefined temperature threshold.

5. The method according to claim 1, wherein the electronic expansion valve is a part of the thermal management device as a first electronic expansion valve disposed upstream of a first evaporator:
when the projected position of the first electronic expansion valve is a closed position, so as to block the circulation of a refrigerant fluid, if a request is made for calibration of said first electronic expansion valve, said calibration is performed on its first stop,
when the projected position of the first electronic expansion valve is an intermediate position, so as to allow the circulation of the refrigerant fluid with a drop in pressure, if a request is made for calibration of said first electronic expansion valve, said calibration is performed on its first stop.

6. The method according to claim 1, wherein the electronic expansion valve is a part of the thermal management device as a second electronic expansion valve disposed upstream of an evaporator-condenser, and where the projected position of the second electronic expansion valve is determined by the forthcoming mode of operation of the thermal management device and if it is an intermediate position, so as to allow the circulation of the refrigerant fluid with a drop in pressure, if a request is made for calibration of said second electronic expansion valve, said calibration is performed on the stop which is the fewest number of steps away.

7. The method according to claim 1, wherein the electronic expansion valve is part of the thermal management device as a second electronic expansion valve disposed upstream of an evaporator-condenser, and wherein the projected position of the second electronic expansion valve is an intermediate position, so as to allow the circulation of the refrigerant fluid with a drop in pressure,
wherein if a request is made for calibration of said second electronic expansion valve:
said calibration is performed on the first stop if the external temperature is lower than the predefined temperature threshold,
said calibration is performed on the second stop if the external temperature is greater than the predefined temperature threshold.

8. The method according to claim 1, wherein the electronic expansion valve is a part of the thermal management device as a second electronic expansion valve disposed upstream of an evaporator-condenser, wherein:
when the projected position of the second electronic expansion valve is a closed position, so as to block the circulation of a refrigerant fluid, if a request is made for calibration of said second electronic expansion valve, said calibration is performed on its first stop,
when the projected position of the second electronic expansion valve is an open position, so as to allow the circulation of the refrigerant fluid with little or no drop in pressure, if a request is made for calibration of said second electronic expansion valve, said calibration is performed on its second stop.

9. The method according to claim 1, wherein the thermal management device has a third electronic expansion valve disposed upstream of a second evaporator, said third electronic expansion valve and second evaporator being disposed in parallel with the first electronic expansion valve and first evaporator:
when the projected position of the third electronic expansion valve is a closed position, so as to block the circulation of a refrigerant fluid, if a request is made for calibration of said third electronic expansion valve, said calibration is performed on its first stop,
when the projected position of the third electronic expansion valve is an intermediate position, so as to allow the circulation of the refrigerant fluid with a drop in pressure, if a request is made for calibration of said third electronic expansion valve, said calibration is performed on its first stop.

10. The method according to claim 1, wherein the electronic expansion valve has a position sensor at each stop so as to determine when said electronic expansion valve is open as far as the stop.

11. The method according to claim 1, wherein the electronic expansion valve has physical stops such that the position of the electronic expansion valve in which it is open as far as the stop is determined by the resistance to rotation perceived by the electric stepper motor.
